(19) United States
(12) Patent Application Publication
(10) Pub. No.: US 2004/0217055 A1
(43) Pub. Date: Nov. 4, 2004

(54) Use of recombinant albumin in dialysis after liver failure

(76) Inventors: Elmar Kraus, Bad Nauheim (DE); Wolfram Eichner, Butzbach (DE)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/797,514

(22) Filed: Mar. 10, 2004

Related U.S. Application Data
(60) Provisional application No. 60/454,061, filed on Mar. 12, 2003.

(51) Int. Cl. B01D 61/00

(52) U.S. Cl. 210/645; 210/321.6; 435/4

(57) ABSTRACT

The present invention relates to the use of recombinant HSA in dialysis, wherein the recombinant HSA has been purified from accompanying fatty acids during its production.

### CROSS-REFERENCE TO RELATED APPLICATIONS

This application claims the benefit of U.S. Provisional Application Serial No. 60/454,061, filed on Mar. 12, 2003, from which priority is claimed under 35 U.S.C. § 119(e)(1), and which is incorporated herein by reference in its entirety.

### TECHNICAL FIELD

The present invention relates to the use of recombinant human serum albumin (HSA) in liver dialysis.

### BACKGROUND

Liver failure represents a severe disease with a high risk of lethal consequences and is often caused by hepatitis virus or intoxication. In case of liver failure, the regeneration of albumin in the liver is inhibited. Since albumin is one of the major transport systems for protein bound substances toxic substances (PBTS) in the blood, this leads to an accumulation of toxic substances in the blood. The ultimate result will be a loss of consciousness and ultimately death of the patient, unless a suitable donor liver is found and transplanted in due time. A removal of those toxic substances from the blood and more precisely from the patient's albumin in the blood via dialysis can help to bridge the time until a suitable transplant is found. In some cases, dialysis may even make transplantation obsolete by giving the liver time to regenerate itself.

Currently, various systems are used to remove toxic substances from albumin. These include replacing the patient's albumin with infused albumin or by directly passing blood of patients over adsorbers based on activated charcoal—a method that can lead to unwanted activation of various blood constituents.

Another approach is the use of a dialysis system as e.g. disclosed in U.S. Pat. No. 5,744,042. Such systems avoid the direct contact of the patient's blood with the purifying substances and use a secondary circuit filled with a substance which can take over the toxic substances bound to the patient's albumin, e.g. an albumin solution. Via a membrane-interface, the transfer of toxic substances occurs from the patient's own albumin to the albumin from the secondary circuit. The latter is then regenerated by passage through one or several adsorbers located in that secondary circuit.

To date, in the dialysis systems mentioned above, human serum albumin is used which normally was prepared from natural sources, e.g. by fractionation of pooled blood collected from numerous blood donors. However, this method of preparation apparently comprises the danger of contamination with infectious agents such as hepatitis virus, human immune deficiency virus, or the infectious agent of new variant CJD, etc. The purification of HSA from human blood therefore includes a long pasteurization step of the final product in order to make a very safe product, but risks cannot be ruled out, especially when considering heat-stable infectious agents. U.S. Pat. No. 5,744,042 discloses that instead of albumin from natural sources, also recombinant albumin could be used.

In the past, it has been noted that the albumin used so far in liver dialysis has a low capacity for toxic proteins. This results in a low efficiency of the dialysis process.

### SUMMARY

The problem underlying the present invention therefore results in providing an improved albumin which increases the efficiency of blood dialysis in liver failure, which at the same time should be available at low costs.

According to one aspect of the present invention, the problem is solved by the use of recombinant HSA in dialysis, wherein the recombinant HSA has been purified from accompanying fatty acids during its production.

Surprisingly, it has been found that recombinant HSA which has been purified from accompanying fatty acids during its production is much more efficient that conventional albumin in dialysis, especially in dialysis after liver failure.

According to a preferred embodiment, the increase in efficiency is at least 10%, preferably at least 25% and more preferred at least 50%.

In one aspect, the invention relates to the use of recombinant HSA in dialysis, wherein the recombinant HSA has been purified from accompanying fatty acids during its production. The recombinant HSA can be further purified from other accompanying substances, preferably proteins or metal ions. The recombinant HSA can be obtained from a transgenic non-human animal or from a transgenic plant. The recombinant HSA can be obtained from a bovine, ovine, porcine, equine, rodent or caprine source. The HSA can be obtained from the milk or blood of the transgenic non-human animal, e.g., milk of a lactating bovine. Alternatively, recombinant HAS can be obtained from an egg of a transgenic bird. The recombinant HSA can be purified from accompanying fatty acids by the use of activated charcoal. The preparation of recombinant HSA can comprise a clarification step. The clarification can be performed by filtration. The preparation of recombinant HSA can comprise the precipitation of the recombinant HSA from a solution containing recombinant HSA. The preparation of recombinant HSA can comprise the precipitation of contaminating proteins from a solution containing recombinant HSA. The preparation of recombinant HAS can comprise a chromatography purification step, e.g., an affinity- or ion exchange chromatography step. The recombinant HSA can be present in the dialysate liquid. The recombinant HSA can be present in the dialysate liquid in a concentration in the range of about 1 about 40% by weight of the composition, e.g., about 5 to about 30% by weight of the composition. The recombinant HSA can be present on a dialysate membrane.

In another aspect, the invention features a dialysate liquid containing recombinant HSA, wherein the recombinant HSA has been purified from accompanying fatty acids during its production. The recombinant HSA can be further purified from other accompanying substances, preferably proteins or metal ions. The dialysate liquid can be bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 1 to about 50 g/100 ml. The dialysate liquid can be bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 6 to about 40 g/100 ml. The dialysate liquid can be bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 8 to about 30 g/100 ml. The dialysate liquid can be bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 8 to about 20 g/100 ml. The dialysate liquid can be acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 1 to about 50 g/100 ml. The dialysate liquid can be acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 6 to about 40 g/100 ml. The dialysate liquid can be acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 8 to about 30 g/100 ml. The dialysate liquid can be acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 8 to about 20 g/100 ml.

In another aspect, the invention features a membrane for the separation of protein-bound substances from a protein-containing liquid (A) containing these substances by dialysis against a dialysate liquid (B) wherein recombinant HSA which has been purified from accompanying fatty acids during its production is attached to at least one side of the membrane and the membrane has such a pore size that the protein-bound substances can pass through the membrane. The recombinant HSA can be further purified from other accompanying substances, preferably proteins or metal ions The membrane can comprise two functionally different parts (regions), one part having an actual separating membrane function permitting the protein-bound substances to pass through and excluding the protein(s) which had bound the protein-bound substances in liquid (A) and the recombinant HSA in liquid (B), and the other part having a port- and adsorption-function, and the membrane being coated on at least one side with a protein having an acceptor function for the protein-bound substances. Alternatively, the membrane can comprise one part having an actual separating membrane function with a tunnel-like structure on the liquid (A) side, the tunnels having a length less than about 10 μm and having a diameter sufficiently small to exclude the protein in liquid (A) and the acceptor protein in liquid (B), and a part with a port- and adsorption-structure on the dialysate liquid (B) side. The length of the tunnels can be less than about 5 μm, e.g., less than about 0.1 μm. The membrane material can be selected from the group consisting of polysulfones, polyamides, polycarbonates, polyesters, acrylonitrile polymers, vinyl alcohol polymers, acrylate polymers, methacrylate polymers, and cellulose acetate polymers.

In another aspect, the invention features a disposable set for the separation of protein-bound substances from plasma or blood containing these substances including a dialyzer comprising a membrane as described herein. The dialyzer can contain on the dialysate liquid (B) side a human serum albumin containing liquid.

The invention also features a disposable set for the separation of protein-bound substances from plasma or blood containing these substances including a dialyzer comprising a membrane as described herein, a second conventional dialyzer for hemodialysis, a conventional charcoal adsorber unit for hemoperfusion, and a conventional ion exchange resin unit for hemoperfusion interconnected by tubing and a unit of a recombinant human serum albumin containing dialysate liquid (B), wherein the recombinant HSA has been purified from accompanying fatty acids during its production.

In another aspect, the invention features a disposable set for the separation of protein-bound substances from plasma or blood containing said substances including a dialyzer comprising a membrane as described herein and being filled on the dialysate liquid (B) side with a human serum albumin containing liquid, a second conventional dialyzer for hemodialysis, a conventional charcoal adsorber unit for hemoperfusion, and a conventional ion exchange resin unit for hemoperfusion interconnected by tubing and a unit of a human serum albumin containing dialysate liquid, wherein the recombinant HSA has been purified from accompanying fatty acids during its production.

In another aspect, the invention features a method for the separation of protein-bound substances from a protein-containing liquid (A) containing these substances comprising dialysing said liquid (A) against a dialysate liquid (B) by means of a membrane, said membrane permitting passage of the protein-bound substances to a dialysate liquid (B) site, and by means of recombinant HSA, said HSA being present either in free form in the dialysate liquid (B) and/or attached to at least one side of the membrane, and wherein the recombinant HSA has been purified from accompanying fatty acids during its production. The recombinant HSA can be further purified from other accompanying substances, preferably proteins or metal ions.

The invention also features a method for the separation of protein-bound substances from a protein containing liquid (A) containing these substances comprising dialyzing said liquid (A) against a dialysate liquid (B) containing recombinant HSA, wherein the recombinant HSA has been purified from accompanying fatty acids during its production and by means of a membrane comprising two functionally different parts, one part, having an actual separating membrane function permitting passage of the protein-bound substances and the water-soluble substances and excluding the protein(s) which had bound the protein-bound substances in liquid (A) and the recombinant HSA in liquid (B), and the other part having a port- and adsorption-function, and the membrane being coated with the recombinant HSA. The recombinant HSA can be further purified from other accompanying substances, preferably proteins or metal ions.

The membrane of such methods can comprise one part having an actual separating membrane function with a tunnel-like structure on the liquid (A) side, the tunnels having a length less than about 10 μm and having a diameter sufficiently small to exclude the protein in liquid (A) and the recombinant HSA in liquid (B), and a part with a port- and adsorption-structure on the dialysate liquid (B) side. The length of the tunnels of the membrane can be less than about 5 μm, e.g., less than about 0.1 μm. The membrane material of such methods can be polysulfones, polyamides, polycarbonates, polyesters, acrylonitrile polymers, vinyl alcohol polymers, acrylate polymers, methacrylate polymers, or cellulose acetate polymers. The protein-containing liquid (A) of such methods can be plasma or blood. The membrane of such methods can be coated with a solution comprising recombinant HSA, wherein the recombinant HSA has been purified from accompanying fatty acids during its production. The dialysate liquid (B) of such methods can comprise recombinant human serum albumin in a concentration from about 1 to about 50 grams per 100 ml, or from about 6 to about 40 grams per 100 ml, or from about 8 to about 30 grams per 100 ml, or from about 8 to about 20 grams per 100 ml.

In another aspect, the invention features the use of recombinant human serum albumin (HSA) for the preparation of a pharmaceutical composition for the treatment of liver failure, wherein the recombinant HSA has been purified from fatty acids during production.

Other features and advantages of the invention will be apparent from the following detailed description, and from the claims. Unless otherwise defined, all technical and scientific terms used herein have the meaning commonly understood by one of ordinary skill in the art to which this invention belongs. All publications, patent applications, patents, and other references mentioned herein are incorporated by reference in their entirety. In case of conflict, the present specification, including definitions, will control. The disclosed materials, methods, and examples are illustrative only and not intended to be limiting. Skilled artisans will appreciate that methods and materials similar or equivalent to those described herein can be used to practice the invention.

### DETAILED DESCRIPTION

According to the invention, the term “dialysis” refers to the ex-vivo method of filtration of body liquids, especially blood.

For the purposes of the present application the term “HSA” is used to refer to human proteins of the albumin superfamily, as originally found in human blood as well as natural or synthetically modified variants thereof. A number of polymorphisms and mutants of human albumin are known to the person skilled in the art (T. Peters, All about Albumin: Biochemistry, Genetics and Medical Applications, Academic Press Incl, 1996) and are covered by the term “HSA” just as well as fragments of the human protein, comprising at least ⅓ and preferably more than ⅔ of the protein sequence.

Other variants may be obtained by substituting, inserting or adding nucleotides to the gene encoding HSA and are covered by the term “HSA” as used in the present application as long as the HSA nucleotide sequence so obtained still has a homology of at least 75% with the natural sequence, wherein a homology of at least 85% is preferred and a homology of at least 90% is most preferred.

In preferred embodiment of the invention, the recombinant HSA is further purified from other accompanying substances, preferably proteins e.g. hormones, or metals or metal ions.

According to the present invention, HSA may be obtained from any source where recombinant HSA can be produced. This includes the production of HSA in prokaryotic or eukaryotic cell lines as well as in any transgenic non-human animal, plants or eggs of transgenic birds. The eukaryotic cell line may also be a yeast strain, although eukaryotic cell lines other than yeast are preferred. Transgenic non-human animals are most preferred.

Methods for the production of HSA in cell lines include the transfection of the cells with a HSA encoding nucleic acid, the cultivation of the cells under conditions permitting the expression of HSA, and the isolation of HSA from the cells. Such methods are known in the art (T. Peters, All about Albumin: Biochemistry, Genetics and Medical Applications, Academic Press Incl, 1996). Also, further information regarding HSA in general and its storage may also be obtained from that literature.

Methods for the production of HSA in transgenic animals are also known in the art. These include the transformation single cells of non-human animals with heterologous DNA encoding HSA and regulatory sequences for expressing that protein in the transgenic animal, as well as the regeneration of transgenic animals (WO91/08216; Bondioli et al., Biotechnology, vol. 16 (1961), 265; Ebert et al., Bio/Technology, vol. 9 (1991), 835; Hammer et al., Nature, vol. 315 (1985), 680; Houdebine L. M. (ed), Transgenic Animals—Generation and Use, Harwood Academic Publishers GmbH (1996), Amsterdam; Pinkert C. A. (ed), Transgenic Animal Technology; A Laboratory Handbook. Academic Press, San Diego (1994), Calif.).

In summary, the cells may be transformed with the nucleic acid by any of the numerous methods known in the prior art. For example, transgenic non-human animals may be obtained using a method comprising introducing the nucleic acid encoding HSA into a suitable non-human recipient cell; and regenerating a transgenic non-human animal from the recipient cell.

The recipient cell is preferably an embryonic cell but other cell types may also be used. Regeneration of the transgenic non-human animal from the embryonic recipient cell may comprise transferring the cell into a female non-human animal and allowing the embryo to grow therein.

The method for producing transgenic non-human animals may further comprise the cloning of animals. Methods for cloning animals are well known to those skilled in the art (Baguisi et al., Nature Biotech., vol 17 (1999), 456-461; Campbell et al., Nature, vol. 380 (1996), 64-66, Cibelli et al., Science, vol. 280 (1998), 1256; Kato et al., Science vol. 282 (1998), 2095-2098; Schnieke et al., Science, vol. 278 (1997, 2130-2133; Vignon et al., C. R. Acad. Sci. Paris, Sciences de la vie/Life Sciences vol. 321 (1998), 735-745; Wakayama et al., Nature, vol. 394 (1998), 369-374Wells et al., Biol. Reprod. vol. 57 (1997), 385-393; Wilmut et al., Nature, vol 385 (1997), 813) and may readily be applied in accordance with the present invention to prepare a large number of transgenic animals.

In the context of the present invention, HSA is preferably obtained from a bovine, porcine, equine, Muridae, other rodents, or caprine source.

In a preferred embodiment, HSA is obtained from the milk or blood of the transgenic non-human animal, preferably from the milk of a lactating bovine (see e.g. WO 96/02573).

In an alternative embodiment, HSA is obtained from an egg of a transgenic bird. The transgenic bird is preferably a chicken. Methods of expressing proteins in transgenic hens so that the protein is transported into the eggs of those hens are known in the art (see for example Morrison et al., Immunotechnology, vol. 4 (1998), p. 115 to 125).

According to the invention, the used recombinant HSA has been purified from accompanying fatty acids and preferably from other accompanying substances during its production. In the context of the present invention, the expression “accompanying fatty acids or substances ” means fatty acids or substances which are attached to HSA during its synthesis in cell lines or transgenic animals or plants. Consequently, these fatty acids or substances are also produced by the cell lines or transgenic animals or plants. Furthermore, the expression “accompanying fatty acids or substances” also means fatty acids or substances which have been attached to the HSA during the extraction or purification process e.g. from cell debris or other components, e.g. metal ions which are released from containers where a solution containing HSA is stored.

In the context of the present invention, the expression “purified from” means that the fatty acids are removed from the HSA in such an extent that the binding capacity of the HSA is increased. In a preferred embodiment of the invention, at least 50%, preferably 70%, more preferably 90% and most preferably 95% of the fatty acids are removed.

Test for the degree of fatty acids are known in the art and are e.g. available form WAKO. One suitable kit is the Nefa-C-kit from WAKO.

Various methods are known in the art for purifying HSA from accompanying fatty acids (see e.g. WO 96/02573). In general, HSA e.g. obtained from transgenic non-human animals needs to be purified from by products to a high degree that otherwise would cause immunological or other side effects when applied.

A suitable method for the purification of HSA from accompanying fatty acids and preferably also from other substances includes mixing the solution containing the recombinant HSA with activated charcoal in a ratio activated carbon:HSA of preferably 1:2 and most preferably at least 1:1. However, other concentrations may also be used, e.g. 2:1 or more.

The activated charcoal may be present in form of powder, granulate, capsules or briquettes.

The purification is preferably performed in a buffer with a pH lower than 3.5, more preferred lower than 3.0.

The buffer is preferably a phosphate buffer. However, also a carbonate buffer or other buffers may be used as long as they have suitable buffering capacities and pH ranges.

The purification is preferably performed at room temperature for preferably at least 30 minutes.

In a preferred embodiment of the present invention, the recombinant HSA is purified from accompanying fatty acids by the use of activated charcoal.

According to a preferred embodiment, the preparation of recombinant HSA comprises a clarification step.

Preferably, the clarification is performed by filtration.

Alternatively or additionally, the preparation of recombinant HSA may comprise the precipitation of the recombinant HSA from a solution containing recombinant HSA. HSA may be e.g. obtained in high purity from the milk or blood of a transgenic non-human mammal by a single precipitation step. Suitable agents capable of precipitating HSA are known in the art and may be identified by the skilled person using simple experiments. Subsequently, HSA may be resuspended in a desired solvent using well-known methods. Preferably, a solvent for HSA is used which simplifies the further purification of HSA (pH, selection of ions).

Furthermore, the preparation of recombinant HSA may comprise the precipitation of contaminating proteins from a solution containing recombinant HSA.

The method of isolating HSA may further comprise one or more chromatography purification steps, which may be performed according to any of the large number of chromatography methods known in the art. The use of an affinity- and/or ion exchange chromatography is preferred (T. Peters, All about Albumin: Biochemistry, Genetics and Medical Applications, Academic Press Incl, 1996).

According to a preferred embodiment, the recombinant HSA is present in the dialysate liquid. According to a preferred embodiment, recombinant HSA is present in the dialysate liquid in a concentration in the range of about 1 to about 40%, preferably of about 5 to about 30% w/vol of the composition and most preferred 20%. With respect to the use in the context of a dialysate liquid, the same embodiments apply as for the dialysate liquid of the invention below.

In dialysis, the recombinant HSA will be used in an amount sufficient or efficient dialysis. This will depend e.g. on the weight of the patient or on the severity of the disease and can be adapted by medical personnel skilled in the art of liver dialysis.

The HSA will be preferably provided in plastic containers sufficient suitable for the storage of high amounts of HSA. Preferably, but not exclusively, this will be a 600 ml package containing a 20% solution (w/vol) of recombinant albumin. Glass standard containers may be used but any type of suitable plastic containers or bags with low gas permeability may be used as well, e.g. bags as used for the collection and storage of blood donations.

According to a further preferred embodiment, the recombinant HSA is present on the dialysate membrane. The embodiments disclosed below for the dialysate membrane of the invention also apply here.

Throughout the invention, it is included that the recombinant HSA is, after the purification from accompanying fatty acids, combined with a defined amount of other fatty acids or related substances, e.g. N-acetyl tryptophane, octanoate or caprylate, in order to e.g. increase solubility of the HSA. Preferably, of these substances, in toto not more than 32 mM are contained in a not more than 20% w/w HSA solution or not more than 40 mM in a not more than 25% w/w HSA solution. Preferably, only one substance is combined with the HSA. Alternatively, two substances in equal amounts may be added.

The invention further relates to a method for dialyzing a patient's blood, wherein recombinant HSA as defined, synthesized, produced and /or purified above is used.

The invention further refers to a dialysate liquid containing recombinant HSA, wherein the recombinant HSA has been purified from accompanying fatty acids during its production.

In a preferred embodiment, the HSA has the features as mentioned above or is synthesized, produced and/or purified as mentioned above.

The dialysate liquid contains recombinant HSA which has been purified from accompanying fatty acids during its production. It serves as an acceptor for the protein-bound substances (PBS) as well as for free substances which may have the potential to bind albumin, which are to be removed from the liquid (A). The concentration of recombinant HSA is preferably from about 1 to about 50 g/100 ml, preferably from about 6 to about 40 g/100 ml, more preferably from about 8 to about 30 g/100 ml and most preferably from about 8 to about 20 g/100 ml.

The dialysate liquid may contain furthermore salts like NaCl, KCl, MgCl2, CaCl2, sodium lactate and glucose monohydrate, in amounts depending on the electrolyte composition in the blood of the specific patient. For example, in the dialysis of a patient suffering hypopotassemia a higher concentration of potassium ions is required.

Preferred ion concentrations in a dialysate liquid that is bicarbonate buffered are for sodium from about 130 to about 145 mmol/1000 ml, for calcium from about 1.0 to about 2.5 mmol/1000 ml, for potassium from about 2.0 to about 4.0 mmol/1000 ml, for magnesium from about 0.2 to about 0.8 mmol/1000 ml, for chloride from 10 about 100 to about 110 mmol/1000 ml, for bicarbonate from about 30 to about 40 mmol/1000 ml, for acetate from about 2 to about 10 mmol/1000 ml, for human serum albumin from about 1 to about 50 g/100 ml, preferably from about 6 to about 40 g/100 ml, more preferably from about 8 to about 30 g/100 ml, and most preferably from about 8 to about 20 g/100 ml.

More preferred ion concentrations in a dialysate liquid that is bicarbonate buffered are for sodium from about 135 to about 140 mmol/1000 ml, for calcium from about 1.5 to about 2.0 mmol/1000 ml, for potassium from about 3.0 to about 3.5 mmol/1000 ml, for magnesium from about 0.4 to about 0.6 mol/1000 ml, for chloride from about 104 to about 108 mmol/1000 ml, for bicarbonate from about 34 to about 38 mmol/1000 ml, for acetate from about 4 to about 8 mmol/1000 ml, for human serum albumin from about 1 to about 50 g/100 ml, preferably from about 6 to about 40 g/100 ml, more preferably from about 8 to about 30 g/100 ml, and most preferably from about 8 to about 20 g/100 ml.

Preferred ion concentrations in a dialysate liquid that is acetate buffered are for sodium from about 130 to about 145 mmol/1000 ml, for calcium from about 1.0 to about 2.5 mmol/1000 ml, for potassium from about 2.0 to about 4.0 mmol/1000 ml, for magnesium from about 0.2 to about 0.8 mmol/1000 ml, for chloride from about 100 to about 110 mmol/1000 ml, for acetate from about 30 to about 40 mmol/1000 ml, for human serum albumin from about 1 to about 50 g/100 ml, preferably from about 6 to about 40 g/100 ml, more preferably from about 8 to about 30 g/100 ml, and most preferably from about 8 to about 20 g/100 ml.

More preferred ion concentrations in a dialysate liquid that is acetate buffered are for sodium from about 135 to about 140 mmol/1000 ml, for calcium from about 1.5 to about 2.0 mmol/1000 ml, for potassium from about 3.0 to about 3.5 mmol/1000 ml, for magnesium from about 0.4 to about 0.6 mmol/1000 ml, for chloride from about 104 to about 108 mmol/1000 ml, for acetate from about 33 to about 38 mmol/1000 ml, for human serum albumin from about 1 to about 50 g/100 ml, preferably from about 6 to about 40 g/100 ml, more preferably from about 8 to about 30 g/100 ml, and most preferably from about 8 to about 20 g/100 ml.

An example for a dialysate liquid comprises from about 10 to about 20% by weight human serum albumin, about 6.1 g NaCl, about 4.0 g sodium lactate, about 0.15 g KCl, about 0.31 g CaCl2×2H2O, 0.15 g MgCl2×6H2O, and 1.65 g glucose monohydrate per liter of dialysate liquid.

If a dialysate liquid according to the invention is used inn the context of dialysate system as described in the present invention or in EP 615780A, any suitable membrane, e.g. coated with acceptor substances can be used. Alternatively, also a membrane according to the invention may be used.

The invention further relates to a membrane for the separation of protein-bound substances from a protein-containing liquid (A) containing these substances by dialysis against a dialysate liquid (B) wherein recombinant HSA which has been purified from accompanying fatty acids during its production is attached to at least one side of the membrane and the membrane has such a pore size that the protein-bound substances can pass through the membrane.

According to a preferred embodiment, the membrane of the invention contains recombinant HSA as defined above which has been synthesized, produced and/or purified as defined above for the use of the invention.

The membrane of the present invention preferably comprises two functionally different parts. One part has the actual separating membrane function permitting the protein bound substances (PBS) and the water-soluble substances to pass through under the conditions of the process of the present invention and excluding the protein(s) which had bound the PBS in liquid (A) and the recombinant HSA of liquid (B), and the other part has a port- and adsorption function. Preferably, the membrane is coated with the recombinant HSA as defined throughout the present invention. In a preferred embodiment the membrane of the present invention comprises a thin layer of a tunnel-like structure facing the liquid (A) side, the tunnels having a length less than about 10 μm and having a diameter sufficiently small to exclude the HSA in liquid (A), and a port- and adsorption-structure on the dialysate liquid (B) side. Preferably, the membrane is coated on at least one side, preferably the dialysate liquid (B) side, with a thin film of recombinant HSA.

The membrane of the present invention may have the macroscopic form of a flat film, a thin-walled but large diameter tube, or preferably fine hollow fibers. Membrane technology, hollow-fiber membranes, and dialysis is described in Kirk-Othmer, Encyclopedia of Chemical Technology, third edition, Vol. 7 (1979), 564-579, in particular 574-577, Vol. 12 (1980), 492-517 and Vol. 15 (1981), 92-131. Furthermore, membranes and membrane separation processes are described in Ullmann's Encyclopedia of Industrial Chemistry, Fifth edition, Vol A 16 (1990), 187-263.

The matrix material for the membrane may be made from many materials, including ceramics, graphite, metals, metal oxides, and polymers, as long as they have an affinity towards the protein on the liquid (A) and the dialysate liquid (B) side. The methods used most widely today are sintering of powders, stretching of films, irradiation and etching of films and phase inversion techniques. The preferred materials for the membranes of the present invention are organic polymers selected from the group consisting of polysulfones, polyamides, polycarbonates, polyesters, acrylonitrile polymers, vinyl alcohol polymers, acrylate polymers, methacrylate polymers, and cellulose acetate polymers. Especially preferred are polysulfone membranes hydrophilized with e.g. polyvinylpyrrolidone.

A precise and complete definition of a membrane is rather difficult; see Ullmann, loc. cit., page 190-191, No. 2.1 and 2.2. A membrane can be homogeneous, microporous, or heterogeneous, symmetric or asymmetric in structure. It may be neutral, or may have functional groups with specific binding or complexing abilities. The most important membranes currently employed in separation processes are the asymmetric membranes; see Ullmann, loc. cit., page 219 et seq., No. 4.2. Known asymmetric membranes have a “finger”-type structure, a sponge-type structure with a graded pore size distribution or a sponge type structure with a uniform pore size distribution; see Ullmann, loc. cit., page 223-224.

The most preferred membrane structure of the present invention is an asymmetric membrane composed of a thin selective skin layer of a highly porous substructure, with pores penetrating the membrane more or less perpendicularly in the form of fingers or channels from the skin downward. The very thin skin represents the actual membrane and may contain pores. The porous substructure serves as a support for the skin layer and permits the recombinant HSA to come close to the skin and to accept the protein-bound substances penetrating the skin from the liquid (A) side towards the dialysate liquid (B) side.

Prior to the separation procedure the membrane is preferably prepared as follows. The membrane is treated from the liquid (A) side and/or from the liquid (B) side with a liquid, preferably a 0.9% NaCl solution, which contains the recombinant human serum albumin in a concentration from about 1 to about 50 g/100 ml, more preferably from about 5 to about 20 g/100 ml. The treatment time is about 1 to about 30 min, preferably about 10 to about 20 min, at a temperature from about 15 to about 40° C., preferably from about 18 to about 37° C.

Details of the Membrane of the Invention

The membrane of the present invention preferably comprises two functionally different parts (regions). One part has the actual separating membrane function permitting the PBS and the water-soluble substances to pass through under the conditions of the process of the present invention and excluding the protein(s) which had bound the PBS in liquid (A) and the recombinant HSA of liquid (B), and the other part has a port- and adsorption function. Preferably, the membrane is coated with recombinant HSA. In a preferred embodiment the membrane of the present invention comprises a thin layer of a tunnel-like structure facing the liquid (A) side, the tunnels having a length less than about 10 μm, preferably less than about 5 μm, more preferably less than about 0.1 μm and most preferably between about 0.01 and about 0.1 μm. The tunnels have a diameter sufficiently small to exclude the protein in liquid (A), preferably to permit the passage of molecules having a molecular weight from about 20,000 daltons to about 66,000 daltons, more preferably from about 50,000 to about 66,000 daltons through the tunnels. Preferably the sieve coefficient of the membrane with respect to the protein in liquid (A) is less than 0.1, more preferably less than 0.01. Furthermore, the membrane preferably comprises a port- and adsorption-structure on the dialysate liquid (B) side. This part has to provide a structure sufficiently open to permit the recombinant HSA in the dialysate liquid (B) to enter the port- and adsorption layer to accept the PBS coming from the liquid (A) side of the membrane. Moreover the internal surface of this part acts as an adsorber for the PBS via the recombinant HSA that is adsorbed by the coating procedure described in the following or by other structures suitable for binding the PBS. This adsorption can either be stable over time or reversible. Preferably the membrane is coated on at least one side with a thin film of the recombinant HSA. A commercial dialyzer comprising a membrane of the present invention may contain on the liquid (B) side a solution of the recombinant HSA.

The membrane of the present invention may have the macroscopic form of a flat film, a thin-walled but large diameter tube, or preferably fine hollow fibers.

The matrix material for the membrane may be made from various materials, including ceramics, graphite, metals, metal oxides, and polymers, as long as they have an affinity towards the protein on the liquid (A) and the dialysate liquid (B) side. The methods used most widely today are sintering of powders, stretching of films, irradiation and etching of films and phase inversion techniques. The preferred materials for the membranes of the present invention are organic polymers selected from the group consisting of polysulfones, polyamides, polycarbonates, polyesters, acrylonitrile polymers, vinyl alcohol polymers, acrylate polymers, methacrylate polymers, and cellulose acetate polymers.

The preferred polymer membranes used in the present invention are highly permeable asymmetric polysulfone membranes hydrophilized with e.g. polyvinylpyrrolidone, e.g. HF 80 of Fresenius AG.

Such membranes and membrane modules, dialysis cartridges, artificial kidney membrane systems are commercially available for instance from Fresenius AG (e.g. HF 80), GAMBRO AB (e.g. Polyflux), Baxter Inc. (e.g. CT190G)

First Part:

The layer or structure of the membrane facing the liquid (A) side has to provide the actual membrane permitting a selective transfer of protein-bound substances and water-soluble substances, i.e. low-molecular substances and “middle sized molecules” from the liquid (A) side to the dialyzing solution (liquid (B) side). Thus, an effective net transport of undesired substances occurs from the liquid (A) side to the dialysate liquid (B) side following the concentration gradient for the undesired substances decreasing from the liquid (A) side towards the dialysate liquid (B) side. Three conditions have to be met for the actual membrane:

The tunnels have to be sufficiently short, preferably less than about 5 μm, more preferably less than about 1 μm, and most preferably less than about 0.1 μm.

The tunnel diameter has to be sufficiently large to permit passage of the undesired molecules and sufficiently small to inhibit passage of the desired molecules contained in liquid (A) towards liquid (B) and of the recombinant HSA from liquid (B) to liquid (A). In case of plasma or blood as liquid (A) the exclusion limit is preferably about 66,000 daltons. Preferably the sieve coefficient of the membrane with respect to the protein in liquid (A) is less than 0.1, more preferably less than 0.01.

The chemical, physical etc. structure of the layer or structure of the actual membrane facing the liquid (A) side is such that passage of the undesired substances is permitted, e.g. by hydrophobic and hydrophilic micro domains.

Second Part:

The layer or structure of the membrane facing the liquid (B) side has to provide a more open membrane structure normally in a sponge- or finger-like fashion. This part provides an important port- and adsorption-function within this part of the membrane:

Due to the open-spaced structure of this part of the membrane the recombinant HSA coming from the dialysate liquid (B) side can approach the dialysate side ostium of the structure facing the liquid (A) side described above and accept undesired substances, such as protein-bound substances passing through the tunnel-like structure from the liquid (A) side.

Due to the large total surface area present in this structure it adsorbs remarkable amounts of the protein-bound substances (PBS) via attached molecules that function as a kind of spacer in this mediate membrane adsorption or the PBS are directly membrane bound if the membrane has a capacity to adsorb the PBS due to its own structure. This adsorption can either be reversible or irreversible but preferably it is reversible.

Due to the open structure towards the dialysate liquid (B) side of the membrane a dialysate movement that might be directed perpendicular or in parallel to the outer membrane surface or in a different fashion can transport HSA molecules both into the port layer and out of the port layer. Preferably the movement and the transport perpendicular to the outer membrane surface is provided by an alternating influx and outflux movement of liquid (B) that moves into the port membrane and back out into the liquid (B) stream. This influx and outflux can be provided by a pulse-like pressure profile obtained by the use of roller pumps or a change in transmembranal pressure changing along the membrane from being directed towards the liquid (B) first (positive TMP) and to the liquid (A) at last (negative TMP); TMP=transmembranal pressure.

Thus, the dialysis membrane of the present invention preferably is functionally divided into a tunnel-like part and a finger- or sponge-like port/adsorption part. Both of them have to fulfill certain prerequisites to render the method of the present invention possible. The ideal tunnel-like part would be one with a length next to zero (0.01 to 0.1 μm), a diameter next to the size of the desired protein to be purified and kept in the retentate, e.g. the diameter of albumin. In other words, the tunnel-like part should have a diameter sufficiently small to retain valuable and desired substances of the liquid (A) in the retentate and to permit protein-bound substances and other undesired substances contained in liquid (A) to pass to the dialysate liquid (B) side.

The ideal port/adsorption part of the dialysis membrane of the present invention has a very open structure to enable the recombinant HSA to approach and leave the area next to the dialysate side of the tunnel. It has a large inner surface which adsorbs the PBS directly or via the attached recombinant HSA. The total diameter of this part should again be as small as possible to render the exchange into the dialysate stream more effective. The latter two points can be brought to their extremes almost excluding the other one according to whether more adsorption or more transit through the port/adsorption part of the membrane is desired.

Conventional dialysis membranes for purifying e.g. plasma or blood can be classified by functional or structural criteria. Functional criteria are high flux, low flux or highly permeable, whereas structural criteria are e.g. flat, hollow fiber, symmetric or asymmetric. The group of tunnel-like membranes (TM) useful for the present invention is not sufficiently described by these terms because TM are high flux and highly permeable membranes but not every high flux membrane named “highly permeable” is a TM (e.g. AN69 from HOSPAL);

TM can be asymmetric but not every asymmetric membrane is a TM (e.g. F8 from FRESENIUS AG);

TM can be asymmetric and highly permeable but not every asymmetric and highly permeable membrane is a TM (PMMA from Toray),

d) TM can be symmetric but not every symmetric membrane is a TM (e.g. Cuprophan from AKZO).

Therefore the term tunnel-like membrane represents a new quality of structural and functional features of dialysis membranes useful for the present invention.

Before use, the membrane of the present invention preferably is pretreated as follows. The membrane is impregnated on at least one side, preferably both from the liquid (A) side and from the liquid (B) side with a solution of the recombinant HSA. A preferred solution for the impregnating step is a 0.9% NaCl solution, containing HSA, in a concentration from about 1 to about 50 g/100 ml, preferably from about 6 to about 40 g/100 ml, more preferably from about 8 to about 30 g/100 ml, and most preferably from about 8 to about 20 g/100 ml. The impregnating solution is passed along the liquid (A) side and the liquid (B) side of the membrane for a time sufficient to permit penetration and adsorption of the recombinant HSA on the two parts of the membrane, in general from about 1 to about 120 min, preferably from about 10 to about 60 min, at a temperature from about 15 to about 40C, preferably from about 18 to about 37C, the pH value being from about 5 to about 9, preferably about 7. The pretreatment can be carried out immediately prior to use of the membrane, but the pretreated membrane may also be stored under sterile conditions at a temperature up to 24C for up to two years.

Preferably the impregnating solution is pumped by roller pumps exhibiting a “pulse like pressure profile” during the coating procedure, e.g. by two roller pumps, one on the dialysate side compartment and one on the blood side compartment of the dialyzer. Preferably there is a phase delay between the pressure profiles of the two pumps thus to ensure an effective in- and outflow of the solution on both sides of the membrane.

The invention also relates to a disposable set for the separation of protein-bound substances from plasma or blood containing these substances including a dialyzer comprising a membrane according to the invention as defined above.

According to a preferred embodiment, the dialyzer contains on the dialysate liquid (B) side a human serum albumin containing liquid.

The invention further relates to a disposable set for the separation of protein-bound substances from plasma or blood containing these substances including a dialyzer comprising a membrane according to the invention, a second conventional dialyzer for hemodialysis, a conventional charcoal adsorber unit for hemoperfusion, and a conventional ion exchange resin unit for hemoperfusion interconnected by tubing and a unit of a recobinant human serum albumin containing dialysate liquid (B), wherein the recombinant HSA has been purified from accompanying fatty acids during its production.

The invention further relates to a disposable set for the separation of protein-bound substances from plasma or blood containing said substances including a dialyzer comprising a membrane according to the invention and being filled on the dialysate liquid (B) side with a human serum albumin containing liquid, a second conventional dialyzer for hemodialysis, a conventional charcoal adsorber unit for hemoperfusion, and a conventional ion exchange resin unit for hemoperfusion interconnected by tubing and a unit of a human serum albumin containing dialysate liquid, wherein the recombinant HSA has been purified from accompanying fatty acids during its production.

The invention further relates to a method for the separation of protein-bound substances from a protein-containing liquid (A) containing these substances comprising dialysing said liquid (A) against a dialysate liquid (B) by means of a membrane, said membrane permitting passage of the protein-bound substances to a dialysate liquid (B) site, and by means of recombinant HSA, said HSA being present either in free form in the dialysate liquid (B) and/or attached to at least one side of the membrane.

The invention further relates to a method for the separation of protein-bound substances from a protein containing liquid (A) containing these substances comprising dialyzing said liquid (A) against a dialysate liquid (B) containing recombinant HSA, wherein the recombinant HSA has been purified from accompanying fatty acids during its production and by means of a membrane comprising two functionally different parts, one part, having an actual separating membrane function permitting passage of the protein-bound substances and the water-soluble substances and excluding the protein(s) which had bound the protein-bound substances in liquid (A) and the recombinant HSA in liquid (B), and the other part having a port- and adsorption-function, and the membrane being coated with the recombinant HSA.

The methods of the present invention for the separation of protein-bound substances and, of course conventional water-soluble substances that may be present, from a protein containing liquid (A) are carried out as follows:

The liquid (A) to be purified is passed through a dialyzer comprising a membrane along the liquid (A) side of the membrane with a flow rate of about 50 to about 500 ml/min, preferably about 100 to about 200 ml/min per one sqm membrane area on the liquid (A) side. The dialysate liquid (B) is passed along the dialysate liquid (B) side of the membrane with a flow rate of about 50 to about 500 ml/min, preferably of about 100 to about 200 ml/min per one sqm membrane area and preferably with the same flow rate as the liquid (A).

The dialysate liquid (B) obtained and containing the protein-bound substances and possibly water-soluble substances from liquid (A) preferably is then passed through a second conventional dialyzer that is connected to a conventional dialysis machine. A dialysis against an aqueous standard dialysate is carried out. By this dialysis water-soluble substances are exchanged between the dialysate liquid (B) and the standard dialysate. Thus, water-soluble toxins such as urea or creatinine can be separated from the dialysate liquid (B) and electrolytes, glucose and pH can be balanced in the dialysate liquid (B) and, therefore, also in liquid (A). The dialysate liquid (B) obtained freed from water-soluble substances preferably is then passed through a charcoal-adsorbent, e.g. Adsorba 300 C from GAMBRO AB or N350 from ASAHI, and an anion exchange column, e.g. BR350 from ASAHI, to remove the protein-bound substances from the HSA in the dialysate liquid (B). The purified dialysate liquid (B) obtained is then returned to the dialysate liquid (B) side of the membrane of the present invention and reused.

In detail, the methods of the invention may be carried out as follows:

Liquid (A) to be purified is passed along the liquid (A) side of the dialysis membrane of the present invention with a flow rate from about 50 to about 300 m/min, preferably from about 100 to about 200 ml/min per sqm of the dialysis membrane. The dialysate liquid (B) is passed along the dialysate side (B) of the membrane with a flow rate from about 50 to about 1000 m/min, preferably from about 100 to about 500 m/min per sqm of the dialysis membrane. The flow rates of the liquid (A) and thus liquid (B) are preferably in the same order of magnitude. The ratio of the flow rate of liquid (A) to liquid (B) is from about 1:0.1 to about 1:10, preferably from about 1:1 to about 1:5. The retentate is the purified protein-containing liquid (A) from which protein-bound substances and other undesired substances are removed.

In a preferred embodiment of the process of the present invention the first dialysis step of the liquid (A) is combined with two steps of after-treatment of the dialysate liquid (B) obtained.

First the dialysate liquid (B) obtained is passed through a second conventional dialyzer which is connected to a conventional dialysis machine. Dialysis is carried out against an aqueous standard dialysate liquid. By this dialysis water-soluble substances can be exchanged between the dialysate liquid (B) and a standard dialysate liquid. Water-soluble toxins, urea and/or creatinine are removed from the dialysate liquid (B), and electrolytes, glucose and the pH value can be balanced in the dialysate liquid (B) which is the retentate. The dialysate liquid (B) is thereafter passed through a charcoal-adsorbent, e.g. Adsorba 300 C from GAMBRO AB or N350 from ASAHI, and then through an anion exchange column, e.g. BR350 from ASAHI, to remove the protein-bound substances from the HSA in the dialysate liquid (B). The purified HSA-containing dialysate liquid (B) is then returned to the liquid (B) side of the membrane of the present invention.

This procedure has been tested in experimental settings in the clinic for the separation of albumin-bound substances and toxins in a protein-containing liquid and led to a significant reduction of these compounds in the liquid.

Other possible simplified embodiments of the procedure of the present invention comprise the following modifications. The dialysate liquid (B) coming from the dialyzer may be passed through another dialyzer but not through any adsorbent. The dialysate liquid (B) coming from the dialyzer may be passed through one or two adsorbents but not through another dialyzer. The dialysate liquid (B) coming from the dialyzer may be pumped directly back into the inlet of the dialysate compartment of the dialyzer (e.g. by a roller pump) thus realizing a sufficient movement of the dialysate liquid (B) and sufficient removal of ABT. A further simple modification would be a dialyzer with a dialysate compartment filled with the dialysate liquid (B) comprising recombinant human serum albumin in a concentration of from about 1 to about 50 g/dl, preferably from about 6 to about 40 g/dl, more preferably between 8 and 30 g/dl, and most preferably from about 8 to about 20 g/dl that is closed at the dialysate inlet and outlet, wherein the recombinant HSA has been purified from accompanying fatty acids during its production. The whole dialyzer may be moved, e.g. by shaking or rolling.

In general, the invention has the advantage that throughout the invention a recombinant HSA is used which has been purified from accompanying fatty acids during its production. This results in a surprisingly higher efficiency of the dialysis process.

### Other Embodiments

The foregoing description is intended to illustrate and not limit the scope of the invention, which is defined by the scope of the appended claims. Other aspects, advantages, and modifications are within the scope of the following claims.

What is claimed is

1. Use of recombinant HSA in dialysis, wherein the recombinant HSA has been purified from accompanying fatty acids during its production.

2. The use according to claim 1, wherein the recombinant HSA is further purified from other accompanying substances, preferably proteins or metal ions.

3. The use according to claims 1 or 2, wherein the recombinant HSA is obtained from a transgenic non-human animal or from a transgenic plant.

4. The use according to claim 3, wherein HSA is obtained from a bovine, ovine, porcine, equine, rodent or caprine source.

5. The use according to claim 4, wherein HSA is obtained from the milk or blood of the transgenic non-human animal.

6. The use according to claim 5, wherein HSA is obtained from the milk of a lactating bovine.

7. The use according to claim 3, wherein, HSA is obtained from an egg of a transgenic bird.

8. The use according to claim 1, wherein the recombinant HSA is purified from accompanying fatty acids by the use of activated charcoal.

9. The use according to claim 8, wherein the preparation of recombinant HSA comprises a clarification step.

10. The use according to claim 9, wherein the clarification is performed by filtration.

11. The use according to claim 1, wherein the preparation of recombinant HSA comprises the precipitation of the recombinant HSA from a solution containing recombinant HSA.

12. The use according to claim 11, wherein the preparation of recombinant HSA comprises the precipitation of contaminating proteins from a solution containing recombinant HSA.

13. The use according to claim 1, wherein the preparation of recombinant HSA comprises a chromatography purification step.

14. The use according to claim 13, wherein the chromatography step involves an affinity- or ion exchange chromatography step.

15. The use according to claim 1, wherein the recombinant HSA is present in the dialysate liquid.

16. The use according to claim 15, wherein HSA is present in the dialysate liquid in a concentration in the range of about 1 about 40% by weight of the composition.

17. The use according to claim 16, wherein the range is of about 5 to about 30% by weight of the composition.

18. The use according to claim 1, wherein the recombinant HSA is present on a dialysate membrane.

19. A dialysate liquid containing recombinant HSA, wherein the recombinant HSA has been purified from accompanying fatty acids during its production.

20. The dialysate liquid according to claim 19, wherein the recombinant HSA is further purified from other accompanying substances, preferably proteins or metal ions.

21. The dialysate liquid according to claims 19 or 20 that is bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 1 to about 50 g/100 ml.

22. The dialysate liquid according to claims 19 or 20 that is bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 6 to about 40 g/100 ml.

23. The dialysate liquid according to claims 19 or 20 that is bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 8 to about 30 g/100 ml.

24. The dialysate liquid according to claims 19 or 20 that is bicarbonate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, bicarbonate from about 30 to about 40 mmol/1000 ml, acetate from about 2 to about 10 mmol/1000 ml, and human serum albumin from about 8 to about 20 g/100 ml.

25. The dialysate liquid according to claims 19 or 20 that is acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 1 to about 50 g/100 ml.

26. The dialysate liquid according to claims 19 or 20 that is acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 6 to about 40 g/100 ml.

27. The dialysate liquid according to claims 19 or 20 that is acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 8 to about 30 g/100 ml.

28. The dialysate liquid according to claims 19 or 20 that is acetate buffered comprising in form of ions sodium from about 130 to about 145 mmol/1000 ml, calcium from about 1.0 to about 2.5 mmol/1000 ml, potassium from about 2.0 to about 4.0 mmol/1000 ml, magnesium from about 0.2 to about 0.8 mmol/1000 ml, chloride from about 100 to about 110 mmol/1000 ml, acetate from about 30 to about 40 mmol/1000 ml, human serum albumin from about 8 to about 20 g/100 ml.

29. A membrane for the separation of protein-bound substances from a protein-containing liquid (A) containing these substances by dialysis against a dialysate liquid (B) wherein recombinant HSA which has been purified from accompanying fatty acids during its production is attached to at least one side of the membrane and the membrane has such a pore size that the protein-bound substances can pass through the membrane.

30. The membrane according to claim 29, wherein the recombinant HSA is further purified from other accompanying substances, preferably proteins or metal ions

31. The membrane according to claims 29 or 30 comprising two functionally different parts (regions), one part having an actual separating membrane function permitting the protein-bound substances to pass through and excluding the protein(s) which had bound the protein-bound substances in liquid (A) and the recombinant HSA in liquid (B), and the other part having a port- and adsorption-function, and the membrane being coated on at least one side with a protein having an acceptor function for the protein-bound substances.

32. The membrane according to claims 29 or 30 comprising one part having an actual separating membrane function with a tunnel-like structure on the liquid (A) side, the tunnels having a length less than about 10 μm and having a diameter sufficiently small to exclude the protein in liquid (A) and the acceptor protein in liquid (B), and a part with a port-and adsorption-structure on the dialysate liquid (B) side.

33. The membrane according to claim 32 wherein the length of the tunnels is less than about 5 μm.

34. The membrane according to claim 32 wherein the length of the tunnels is less than about 0.1 μm.

35. The membrane according to claims 29 or 30 wherein the membrane material is selected from the group consisting of polysulfones, polyamides, polycarbonates, polyesters, acrylonitrile polymers, vinyl alcohol polymers, acrylate polymers, methacrylate polymers, and cellulose acetate polymers.

36. The membrane according to claim 35 wherein the membrane material is a polysulfone.

37. A disposable set for the separation of protein-bound substances from plasma or blood containing these substances including a dialyzer comprising a membrane according to claims 29 or 30.

38. The disposable set according to claim 37 wherein the dialyzer contains on the dialysate liquid (B) side a human serum albumin containing liquid.

39. A disposable set for the separation of protein-bound substances from plasma or blood containing these substances including a dialyzer comprising a membrane according to claims 29 or 30, a second conventional dialyzer for hemodialysis, a conventional charcoal adsorber unit for hemoperfusion, and a conventional ion exchange resin unit for hemoperfusion interconnected by tubing and a unit of a recombinant human serum albumin containing dialysate liquid (B), wherein the recombinant HSA has been purified from accompanying fatty acids during its production.

40. A disposable set for the separation of protein-bound substances from plasma or blood containing said substances including a dialyzer comprising a membrane according to claims 29 or 30 and being filled on the dialysate liquid (B) side with a human serum albumin containing liquid, a second conventional dialyzer for hemodialysis, a conventional charcoal adsorber unit for hemoperfusion, and a conventional ion exchange resin unit for hemoperfusion interconnected by tubing and a unit of a human serum albumin containing dialysate liquid, wherein the recombinant HSA has been purified from accompanying fatty acids during its production.

41. A method for the separation of protein-bound substances from a protein-containing liquid (A) containing these substances comprising dialysing said liquid (A) against a dialysate liquid (B) by means of a membrane, said membrane permitting passage of the protein-bound substances to a dialysate liquid (B) site, and by means of recombinant HSA, said HSA being present either in free form in the dialysate liquid (B) and/or attached to at least one side of the membrane, and wherein the recombinant HSA has been purified from accompanying fatty acids during its production.

42. The method of claim 41, wherein the recombinant HSA is further purified from other accompanying substances, preferably proteins or metal ions.

43. A method for the separation of protein-bound substances from a protein containing liquid (A) containing these substances comprising dialyzing said liquid (A) against a dialysate liquid (B) containing recombinant HSA, wherein the recombinant HSA has been purified from accompanying fatty acids during its production and by means of a membrane comprising two functionally different parts, one part, having an actual separating membrane function permitting passage of the protein-bound substances and the water-soluble substances and excluding the protein(s) which had bound the protein-bound substances in liquid (A) and the recombinant HSA in liquid (B), and the other part having a port- and adsorption-function, and the membrane being coated with the recombinant HSA.

44. The method of claim 43, wherein the recombinant HSA is further purified from other accompanying substances, preferably proteins or metal ions.

45. The method of claims 41 or 43, wherein the membrane comprises one part having an actual separating membrane function with a tunnel-like structure on the liquid (A) side, the tunnels having a length less than about 10 μm and having a diameter sufficiently small to exclude the protein in liquid (A) and the recombinant HSA in liquid (B), and a part with a port- and adsorption-structure on the dialysate liquid (B) side.

46. The method of claim 45 wherein the length of the tunnels of the membrane is less than about 5 μm.

47. The method of claim 46 wherein the length of the tunnels of the membrane is less than about 0.1 μm.

48. The method of claims 41 or 43 wherein the membrane material is selected from the group consisting of polysulfones, polyamides, polycarbonates, polyesters, acrylonitrile polymers, vinyl alcohol polymers, acrylate polymers, methacrylate polymers, and cellulose acetate polymers.

49. The method of claim 48 wherein the membrane material is a polysulfone.

50. The method of claims 41 or 43 wherein the protein-containing liquid (A) is selected from the group consisting of plasma and blood.

51. The method of claims 41 or 43 wherein the membrane is coated with a solution comprising recombinant HSA, wherein the recombinant HSA has been purified from accompanying fatty acids during its production.

52. The method of claims 41 or 43 wherein the dialysate liquid (B) comprises recombinant human serum albumin in a concentration from about 1 to about 50 grams per 100 ml, preferably from about 6 to about 40 grams per 100 ml, more preferably from about 8 to about 30 grams per 100 ml, even more preferably in a concentration from about 8 to about 20 grams per 100 ml.

53. Use of recombinant human serum albumin (HSA) for the preparation of a pharmaceutical composition for the treatment of liver failure, wherein the recombinant HSA has been purified from fatty acids during production.
